(19) United States
(12) Patent Application Publication
(10) Pub. No.: US 2008/0091652 A1
(43) Pub. Date: Apr. 17, 2008

(54) Keyword search by email

(76) Inventor: Attilio Tonelli, San Miguel Allende (MX)

Correspondence Address: FURR LAW FIRM, 2622 DEBOLT ROAD, UTICA, OH, 43080, US

(21) Appl. No.: 11/549,652

(22) Filed: Oct. 15, 2006

(51) Int. Cl. G06F 17/30

(52) U.S. Cl. 707/3

(57) ABSTRACT

The present invention is a Keyword search by email system and procedures to allow a user to receive by email information related to any subject of his interest (products, services, persons or companies, news, events, any other subject) by submitting through email a search under the form of a text describing the subject of their interest. The Keyword search by email system can greatly reduce and possibly eliminate completely the problem known as “click fraud.” In fact, sponsored links included in the information sent by email are shown only and exclusively to the user who performed the keyword search by email.

### CROSS-REFERENCES TO RELATED APPLICATIONS (IF ANY)

None

### STATEMENT AS TO RIGHTS TO INVENTIONS MADE UNDER FEDERALLY-SPONSORED RESEARCH AND DEVELOPMENT (IF ANY)

None

### BACKGROUND

1. Field of the Invention

This invention relates generally to a Keyword search by email system, and more particularly to the process that allows for the reduction of click fraud.

2. Description of Prior Art

With the increasing popularity of the Internet and the global workplace, many companies are selling and paying for advertisement on the Internet. A popular method of payment for this advertisement is to pay an advertiser for the number of times that a potential customer goes to the seller's website through a hyper-text link on the advertiser's website. This can be called a click. One of the major issues with this type of payment plan is click fraud, which is where an advertiser or someone on behalf of the advertiser, clicks on the hyper-link with no intention of buying the seller's product but with the intention of increasing the number of “clicks” and therefore the amount of compensation that the advertiser receives.

Click fraud most commonly happens when advertisers, who get a portion of the fees earned by a search engine each time a link is clicked, deliberately generate excessive clicks with no chance that any of the clicks will result in a sale for the business that is paying for them.

These clicks can be generated through automated programs or by paying people to click over and over on a link.

Click Fraud can also occur when competitors who are in the same business on a list of paid search results clicks so much on a competitor's ad in a goal to push the rival over its spending limit, as Companies typically set a daily budget for individual search terms as well as their entire campaign. This will knock them out of paid search listings for the day.

Click Fraud needs to be reduced and eliminated if this type of advertising is going to survive. There exists room for improvement in the art.

### PRIOR ART

U.S. Pat. No. 6,938,033 by Schutzer and issued on Aug. 30, 2005, is for a system and method of using e-mail centered internet interaction. It discloses an invention that allows an e-mail server to process requests for Web pages and forward copies of the requested Web pages as attachments to e-mail messages.

U.S. Pat. No. 6,768,991 by Hearnden and issued on Jul. 27, 2004, is for a searching for sequences of character data. It discloses a modified Boyer-Moore searching algorithm used within an E-mail filtering system for detecting the presence of a plurality of target band strings during a single traversal of the character data to be searched.

U.S. Pat. No. 6,275,820 by Navin-Chandra, et al. and issued on Aug. 14, 2001, is for a system and method for integrating search results from heterogeneous information resources. It discloses a system and method for relative ranking and contextual summarization of search hits from multiple distributed, heterogeneous information resources based upon the original content of each hit.

U.S. Pat. No. 6,230,156 by Hussey and issued on May 8, 2001, is for an electronic mail interface for a network server. It discloses a networked system for processing queries for a server in a distributed processing environment. The system includes a plurality of clients disposed for communication with a database server through an electronic mail system. The server includes an electronic mail interface for receiving queries submitted by the clients and for transmitting the corresponding responses.

U.S. Pat. No. 5,873,077 by Kanoh, et al. and issued on Feb. 16, 1999, is for a method and apparatus for searching for and retrieving documents using a facsimile machine. It discloses an invention that obtains documents by receiving a facsimile transmission of a document with at least one search term and performing a search based on search terms on the received document.

United States Patent Application 20040215506 by Mcewan, et al. and published on Oct. 28, 2004, is for interactive commercials as interface to a search engine. It discloses an invention in which user submits a search request to an Internet or other network search engine from within an e-mail client.

There is still room for improvement within the art.

### SUMMARY OF THE INVENTION

The present invention is a Keyword search by email system and procedures to allow a user to receive by email information related to any subject of his interest (products, services, persons or companies, news, events, any other subject) by submitting through email a search under the form of a text describing the subject of their interest. The Keyword search by email system can greatly reduce and possibly eliminate completely the problem known as “click fraud.” In fact, sponsored links included in the information sent by email are shown only and exclusively to the user who performed the keyword search by email.

The process is more efficient, effective, and functional than the current art.

### GLOSSARY OF TERMS

Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Cookies: data blocks that are transmitted to a client browser by a web site.

Hit: the event of a browser requesting a single Web component.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Server host: a computer on the Internet that hands out Web pages through a Web server program.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Visit: a series of requests to a fixed Web server by a single person (through a browser), occurring contiguously in time.

Web master: the (typically, technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF THE DRAWINGS

Without restricting the full scope of this invention, the preferred form of this invention is illustrated in the following drawings:

FIG. 1 shows an overview of the accessing of the system;

FIG. 2 shows the user sending an E-mail for the search; and

FIG. 3 shows a response coming back from the search.

### DESCRIPTION OF THE PREFERRED EMBODIMENT

Below is the preferred embodiment of the current invention, but it is not the only embodiment of the current invention and should not be read as such.

The present invention relates to system 1 that is a Keyword search by email system and procedures to allow a user to receive by email information related to any subject of his interest (products, services, persons or companies, news, events, any other subject) by submitting through email a search under the form of a text describing the subject of his interest.

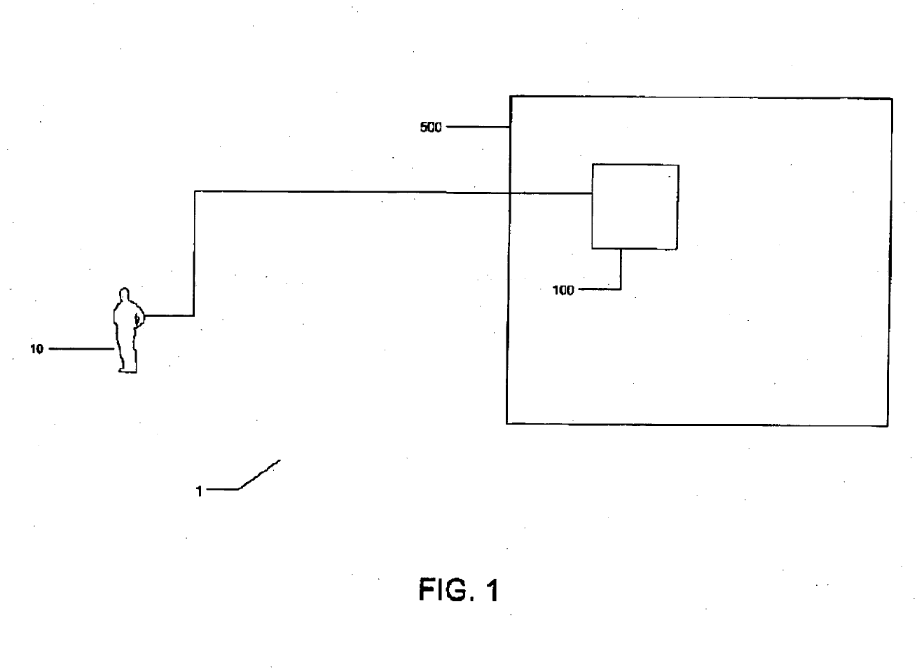

FIG. 1 illustrates a functional diagram of a computer network for World Wide Web 500 access to the System 1 from a plurality of Users 10 who access the system Web Site 100 or the Users 10 can connect directly to the System 1. Accessing the System Web Site 100 can be accomplished directly through a communication means such as a direct connection, an intranet, a local Internet Service Provider, often referred to as ISPs, or through an on-line service provider like CompuServe, Prodigy, American Online, etc. or Wireless devices using services like AT&T or Verizon. Each user 10 will have a computer 15, with display device such as a monitor and input device like a keyboard. This display and input device can even be a PDA like a Blackburn.

The Users 10 contact the System Web Site 100 using an informational processing system (Client) capable of running an HTML compliant Web browser such as Microsoft's Internet Explorer, Netscape Navigator, Lynx and Mosaic and/or with an E-mail system such as Outlook, Hotmail or AOL. A typical system that is used is a personal computer with an operating system such as Windows 95, 98 or ME, NT, 2000 or Linux, running a Web browser. The exact hardware configuration of computer used by the Users 10, the brand of operating system or the brand of Web browser configuration is unimportant to understand this present invention.

In one preferred embodiment of the invention, the Users 10 connect to the System Web Site 100. The system 1 allows for secure input, data transfer and storage of a wide array of information which is stored on a database 310. The data processing system 1 for both embodiments includes computer processing means for processing data, storage means for storing data on a storage medium, and communication means for transferring data in a secure environment.

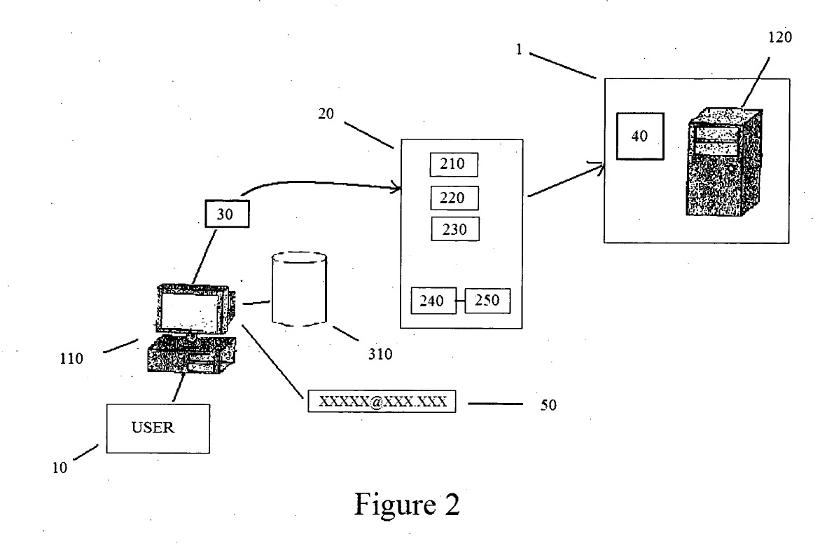

As shown in FIG. 2, the system 1 comprises a choice of software interfaces 20, any of which allows the user 10 to provide the data required to perform a keyword search (as well as additional data optionally provided by the user). Then upon activation by the user of a specific command, the software interface sends by email 30 the data provided by the user 10 to a default email address 50.

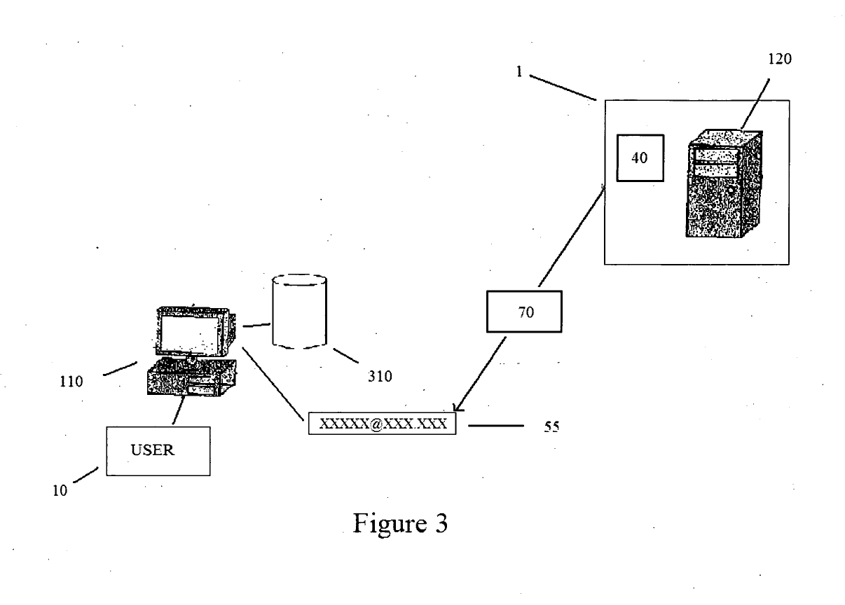

The system 1 has a back end system management 40 controlling the server that hosts the email address to which is directed the user's search and performs through the interaction of software procedures and human staff the following tasks: analyse the data provided by the user to extract the relevant information describing the user's search, produce a response to the user's search containing a set of information as pertinent as possible to the search, send by email 30 to the user 10 the response 70 produced as shown in FIG. 3.

The procedures which allow the user 10 to perform the keyword search by email 30 and then to receive in response by email information related to his search's subject, is as follows: The user 10 installs and then executes, on his own server or computer, one of the software interfaces 20 or the web based software interfaces 230 or, on alternative, to access a web based email client which has installed one of the software interfaces.

Using the software interfaces, the user 10 provides text that will describe any subject (product, service, person or company, news, event, any other subject) about which the user 10 wants to perform a search on what the user 10 wants to receive information on. The text describing the subject of the search can be either a sequence of keywords (separated by any separator) or a description in natural language.

Using the software interfaces 20 allows the user 10 to start the transmission by email 30 of the search by clicking on command button (or any other command activation tool). The user does not need to specify any email address when submitting his search as the software interface 20 keeps stored a destination email address 50 which is used by default.

Once the user 10 activates the email transmission of his search, in the preferred embodiment, the software interface 20 sends via email 30 to a default email address 50 hosted on a server under control of the back end system management 40 the following data: the text describing the search's subject, the user's IP address, and any other additional information optionally provided by the user 10.

The server controlled by the back end system management 40 receives by email 30 the data sent by the software interface 20.

The text describing the search's subject, the user's IP address and any other optional information provided by the user are analyzed by software and/or humans to produce a response to the user's search containing information as relevant as possible with: Relevant keyword/s contained in the text describing the user search's subject User's IP address (from which, for example, can be established the user's geographic area), and any other additional information optionally provided by the user such as gender, age, family status, geographic location related to the search if different by the one obtained form the IP address, or any other additional information.

The set of information produced is sent by email 30 to the user 10 as response to the user's search.

The system 1 and procedures are to guarantee that the email address of the user 10, the content of his search, his IP, as well as any other information the user decides to provide are not disclosed to any third party.

The system 1 performs a validation check to ensure that any user 10 utilizing the system I is providing a valid email address under their control. It uses security encrypting of all the data interchanged between the user's server 110 and the server 120 controlled by the system management, to ensure that all of the data provided by the user 10 are not visible to any third party and are utilized only to provide to the user information strictly related to their search.

The system 1 stores all the information provided by the user only and exclusively on the user's server in a database 310. This information is under total and exclusive control of the user 10. The user 10 can delete or make the information inaccessible. The system 1 will use the information related to each specific search only to produce the requested response. Once the response is submitted by email 30 to the user 10 all the information is deleted from the system server 120, unless the user 10 specifically authorizes the system 1 to keep stored part or all of the information which the system 1 can use to provide a faster and better response to future inquiries.

The system 1 can use different formats of software interfaces 20 which allow the user 10 to perform keyword inquiries by email 30. Each email 30 will have a validation check performed to ensure that they are valid and under control of the user 10.

One of these software interfaces is a stand alone application 210 which can be either downloaded online or installed from a portable memory device such as a CD. When the stand alone application 210 is installed on the user's computer 15 and launched it shows a search form where the user 10 can type the text describing the subject of their search. In the preferred embodiment, the application 210 shows a “send search” button or other command activation tool which, when clicked by the user 10, activates the search's transmission by email 30 to a default email address 50 hosted on a system server 120.

The application 210 provides the user 10 the ability to configure options and preferences such as: which user's email address or addresses 55 the response 70 to the search is to be sent; in which formats the user 10 prefers to receive the response 70 to his search (such as text, html, other specific format) as well as the maximum size allowed for the set of information contained in the search's response; whether the user 10 want the system 1 to provide and store additional personal information (such as age, gender, hobbies, interests, .etc) to be added to their profile, which together with the search's description and the user's IP address are then sent by email 30 to the system 1 and used by the system 1 to produce a set of information as related as possible to the user's search; whether the user 10 wants the response 70 to be stored only on the user's server 110, which is the default, or if the user 10 wants to allow some information to be stored on the system server 120 controlled by the system 1, allowing the system 1 to provide faster and better responses to future user's 10 inquiries.

The user 10 will be able to uninstall the system 1 completely from their server 110 and permanently delete all the information ever exchanged with the system 1.

This stand-alone interface 210 can work also without being connected to Internet 500. It can collect the searches and store them, and then as soon as an internet connection is established the system 1 will send by email 30 all the pending inquiries previously stored.

One of these software interfaces is a patch (add-on) module 220 which can be either downloaded online or installed from a portable memory device such as a CD. When launched the patch (add-on) module 220 will install itself as an addition of the default email client software present on the user's computer 15. When activating the “compose new email” command of their email client software the user 10 can type in any of the fields of the email form (either to: and/or subject: and/or cc: and/or bcc: and/or body) the text describing the subject of their search. When the user 10 hits the “send email” button of their email client software the patch (add-on) module 220 will check to see if the user is sending a standard email 30 to a specific address where the patch (add-on) module 220 will check the presence of an email address in the to: , cc:, bcc: fields and other checks to verify if the user 10 is sending a standard email. If the check result is negative that the user 10 is not sending a standard email 30 to specific email address then the patch (add-on) module 220 will send the text describing the user's search, the user's IP address and any other information provided by the user 10 on their profile to a default email address 50 hosted on a server 120 under control of the system 1. If the patch (add-on) module 220 detects that the user 10 is sending a standard email it will just quit and let the email client software complete its standard functions.

The add-on module 220 provides to the user 10 the ability to configure options and preferences such as: to which of the user's email addresses 55 the search's response 70 is to be sent to. By default the user's email address used to send the search will be the one used, in what formats the user 10 prefers to receive the response 70 such as text, html, other specific format supported by the system, the maximum size allowed for the response 70, the option for the user 10 to provide and store additional personal information like age, gender, hobbies and interests, .etc to be added to their profile, which together with the search's description and the user's IP address are then sent by email 30 and used by the system 1 to produce a set of information as related as possible to the user's search. The add-on module 220 will allow the user 10 to have the add-on software showing an additional command, for example a “send search” button, to his email software user interface to be used instead of the standard “send mail” command. The add-on module 220 will allow the user 10 to have the add-on software adding to his email client user interface a selection tool which allows the user 10 to select categories and subcategories to further refine his keyword search.

The user 10 will have the option to uninstall completely the add-on module 220 from his server 110 and permanently delete all the information ever exchanged with the system 1. This patch (add-on) module 220 interface can work also without being connected to internet 500. It can collect searches and store them, and then as soon as an internet connection is established the interface will send by email 30 all the pending inquiries previously stored.

The software interface 20 can be also implemented and used as web based software interface 230, which is a website 100 that shows the user 10 a box where to type the text describing the search's subject and a “send search” button to activate the transmission by email 30 to a default email address of the user's search. The web based software interface 230 will also perform a validation check of each user 10 using the system 1 in order to achieve the email address 55 where to send back the response 70 to the search and at the same time ensure that the user 10 utilizing the system is providing a valid email address 55 under their control. The web based interface 230, in the preferred embodiment, has a selection tool which allows the user 10 to select categories and subcategories to further refine their search. The web based interface 230 can also offer to the users 10 the option to download other software interfaces 20 such as the stand alone application 210 and add-on module 220 which allow the user 10 to perform inquiries locally without accessing the web based interface 230.

The web based interface 230 provides the user 10 the ability to open an account. The user 10 follows a standard login procedure allowing the user 10 to provide a logon username and password. The system 1 will allow the user 10 to configure options and preferences such as: to which user's email addresses 55 the response 70 to user's search is to be sent with a validation check performed for each email address provided; in which formats the user 10 prefers to receive the response 70 to their search such as text, html, or other specific format, as well as the maximum size allowed for the set of information contained in the search's response, the option for the user 10 to provide and store additional personal information like age, gender, hobbies and interests, . . . etc to be added to their profile, which together with the search's description and the user's IP address are then sent by email 30 and used by the system 1 to produce a set information as relevant as possible to the user's search, and the option for the user 10 to choose what information is stored only on the user's server 110, which will be the default and what is to be stored on the system's server 120 to allow the system to provide faster and better responses to future user's inquiries.

The user 10 can cancel his account and permanently delete all the information ever exchanged with the system

Once the user 10 has opened an account and configured his options and preferences he can log in and then perform as many inquiries as he likes through the web based interface without specifying and validating an email address 55 for each search submitted.

The software interface 20 can be also distributed as an internet add-on module 240 specifically designed for web-based email client 250 such as hotmail, gmail, yahoo mail, msn mail, or any other. The internet add-on module 240 would be added to the web based email client 250 to provide the following functionalities: when activating the “compose new email” command of the web based email client 250 the user 10 can type in any of the fields of the email form, either to: and/or subject: and/or cc: and/or bcc: and or body, the text describing the subject of his search. When the user 10 hits the “send email” button of the web based email client 250 the internet add-on module interface is invoked to verify if the user 10 is sending a standard email 30 to a specific address. If the check result is negative where the user 10 is not sending a standard email 30 to specific email addresses 50 then the internet add-on module 240 will send the text describing the user's search, the user's IP address and any other information provided by the user 10 on his profile to a default email address hosted on a system server 120. If the internet add-on module 240 detects that the user 10 is sending a standard email it will just quit and let the web based email client 250 complete its standard functions.

The internet add-on module 240 for web based email client 250 allows the user 10 the ability to configure options and preferences such as: to which user's email addresses 55 the response 70 to user's search is to be sent with a validation check performed for each email address provided; in which formats the user 10 prefers to receive the response 70 to their search such as text, html, or other specific format, as well as the maximum size allowed for the set of information contained in the search's response, the option for the user 10 to provide and store additional personal information like age, gender, hobbies and interests, etc to be added to their profile, which together with the search's description and the user's IP address are then sent by email 30 and used by the system 1 to produce a set of information as relevant as possible to the user's search, and the option for the user 10 to choose what information is stored only on the user's server 110, which will be the default and what is to be stored on the system's server 120 to allow the system to provide faster and better responses to future user's inquiries.

The internet add-on module 240 for web based email client 250 will allow for the user 10 to have an additional command, for example a “send search” button, to the web based email user interface to be used instead of the standard “send mail” and to allow the user 10 to have the add-on software adding to the web based email client user interface a selection tool which allows the user 10 to select categories and subcategories to further refine his keyword search and the option for the user 10 to choose what information is stored only on the user's server 110, which will be the default and what is to be stored on the system's server 120 to allow the system to provide faster and better responses to future user's inquiries.

The user 10 can cancel his account and permanently delete all the information ever exchanged with the system

### Advantages

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. An information search system comprising;
having a user request information in an E-mail, having the user send the E-mail and
having the response sent back to the user E-mail originating the request or to the E-mail specified by the user.

2. An information search system according to claim 1 where said search is a keyword search.

3. An information search system according to claim 1 wherein a software interface is used.

4. An information search system according to claim 3 wherein said software interface is an application.

5. An information search system according to claim 3 wherein said software interface is a stand alone application.

6. An information search system according to claim 3 wherein said software interface is a patch add-on module.

7. An information search system according to claim 3 wherein said software interface is a web-based software interface.

8. An information search system according to claim 1 wherein said user provides text on which to search on.

9. An information search system according to claim 1 wherein said response is sent back to the user E-mail originating the request or to the E-mail specified by the user on his profile.

10. An information search system according to claim 1 wherein said information request is sent to a default E-mail address stored in the system software interface.

11. An information search system according to claim 1 wherein a verification process is performed on each E-mail originating a request or provided by the user on his profile.

12. An information search system according to claim 1 wherein said information request sent by the user as well as said response sent by the system are encrypted.

13. An information search system according to claim 1 wherein said system will store searches until the user's computer connects to the Internet.

14. An information search system according to claim 1 wherein said user can store profile information on the system.

15. An information search system according to claim 1 wherein said default address is stored by the system.

16. An information search system comprising;
having a user request information in an E-mail, having the user use a software interface to send the E-mail to a default E-mail address stored in said software interface and having the response sent back to the user E-mail originating the request or to the E-mail specified by the user on his profile, where said search is a keyword search, where said user request information provides text on which to search on, where said response is sent back to a specified E-mail, where a verification process is performed on each E-mail.

17. An information search system according to claim 3 wherein said software interface is a stand alone application.

18. An information search system according to claim 3 wherein said software interface is a patch add-on module.

19. An information search system according to claim 3 wherein said software interface is a web-based software interface.

20. An information search system according to claim 1 wherein said response is sent back to a default E-mail if a specified E-mail address is not provided.
